(19) United States
(12) Patent Application Publication
(10) Pub. No.: US 2017/0092089 A1
(43) Pub. Date: Mar. 30, 2017

(54) Security monitoring apparatus, camera having the same and security monitoring method

(71) Applicants: Tianjin Hualai Technology Co., Ltd., Tianjin (CN); iSmart Alarm, Inc., Sunnyvale, CA (US)

(72) Inventor: Ting YE, Tianjin (CN)

(21) Appl. No.: 14/927,140

(22) Filed: Oct. 29, 2015

(30) Foreign Application Priority Data
Sep. 30, 2015 (CN) 201510639758.4
Sep. 30, 2015 (CN) 201520769974.6

(51) Int. Cl. G08B 13/22; H04N 7/18

(52) U.S. Cl. CPC G08B 13/22; H04N 7/18

(57) ABSTRACT

A security monitoring method comprises: collecting audio information for a monitored region; judging whether the collected audio information contains feature audio information; generating an alarming message corresponding to the feature audio information if it is determined that the collected audio information contains the feature audio information; and transmitting the alarming message to an external device. A security monitoring apparatus and a camera including the same are also provided.

### CROSS-REFERENCE TO RELATED APPLICATIONS

The present application claims priority under 35 U.S.C. §119 to Chinese Patent Application No. 201510639758.4 filed on Sep. 30, 2015 and Chinese Patent Application No. 201520769974.6 filed on Sep. 30, 2015 before the State Intellectual Property Office of China, which are incorporated by reference herein in their entirety.

### TECHNICAL FIELD

The disclosed embodiments relate to a security monitoring apparatus, a camera having the same and a security monitoring method.

### BACKGROUND

As an important way of monitoring a region and a vicinity thereof to ensure safety, security monitoring has been more and more widely used. In existing security monitoring methods, generally video data and audio data collected in real time for monitored regions are transmitted to monitoring personnel who will analyze the data to ensure safety of the regions. However, there are many problems in these methods which depend on personnel. For example, if a monitored region is a home of a user, it is not suitable to arrange a dedicated person to monitor the region due to privacy. In this case, if an accident such as fire with a lot of smoke or carbon monoxide leak occurs while there is no one at home or only elderly or children at home, although video data and audio data will be recorded by current home monitoring cameras, the accident cannot be recognized in time and no corresponding actions can be taken in time. In addition, although the current smoke alarms and carbon monoxide alarms installed at home can recognize smoke and carbon monoxide respectively, no prompt actions can be taken if no family member having handling capability is at home. Thus, a severe consequence such as loss of property or lives may happen.

### SUMMARY

In view of this, embodiments of the present invention are dedicated to a security monitoring apparatus, a camera having the same and a security monitoring method which are capable of reporting an accident in a monitored region automatically and reminding a relevant user in time.

According to embodiments of the present invention, a security monitoring method comprises: collecting audio information for a monitored region; judging whether the collected audio information contains feature audio information; generating an alarming message corresponding to the feature audio information if it is determined that the collected audio information contains the feature audio information; and transmitting the alarming message to an external device.

The method may further comprise collecting video information for the monitored region. The method may further comprise storing the video information and/or the audio information collected for a preset time period. The video information and/or the audio information collected for the preset time period may be stored in a local storage, the external device is a client terminal of a user. The video information and/or the audio information collected for the preset time period may be stored in a cloud server, the external device is the cloud server, wherein the method may further comprise transmitting the alarming message to a client terminal of a user by the cloud server using a message pushing service.

Judging whether the collected audio information contains feature audio information may comprise: taking sampling to the collected audio information to form time domain audio information, and dividing the time domain audio information into a plurality of time domain information sections according to time order; implementing Fourier transform to the plurality of time domain information sections to obtain a plurality frequency domain information sections; intercepting a portion having frequencies in a feature frequency range respectively for each of the frequency domain information sections as a feature information section; judging whether an amplitude of each of the feature information sections satisfies a preset condition, recording the feature information sections having amplitudes which satisfy the preset condition as valid information sections, and recording the other feature information sections as invalid information sections; combining time domain waveforms corresponding to all of the valid information sections and the invalid information sections according to the time order to obtain a feature time domain waveform; and judging whether the feature time domain waveform matches waveform parameters of the feature audio information, and if so, determining that the collected audio information contains the feature audio information.

Judging whether an amplitude of each of the feature information sections satisfies a preset condition may comprise judging whether the amplitude of each of the feature information sections is greater than a preset first threshold, and may further comprise: calculating vibration volumes for at least one frequency other than the frequency corresponding to the amplitude; calculating a ratio of the amplitude to each of the vibration volumes for the at least one frequency respectively; and judging whether each of the ratios is greater than a preset second threshold.

Before intercepting a portion having frequencies in a feature frequency range respectively for each of the frequency domain information sections as a feature information section, the method may further comprise: dividing each of the frequency domain information sections into a plurality of frequency bands according to frequency; calculating an average vibration volume for each of the frequency bands; calculating a ratio of the average vibration volume of a frequency band corresponding to the feature frequency range to the sum of the average vibration volumes of all of the other frequency bands; and determining that the current frequency domain information section does not contain the feature information section if the ratio is falling within a preset ratio range, and terminating processing for the current frequency domain information section.

The feature audio information may comprise one or more of alarming audio from a smoke alarm, alarming audio form a carbon monoxide alarm and self-defined alarming audio after pre-learning.

According to embodiments of the present invention, a security monitoring apparatus comprises: an audio collecting device for collecting audio information for a monitored region; a processor, comprising a receiving module for receiving the audio information collected by the audio collecting device, a judging module for judging whether the collected audio information contains feature audio information, and an alarming module for generating an alarming message corresponding to the feature audio information if it is determined that the collected audio information contains the feature audio information; and a transmitting device for transmitting the alarming message to an external device.

The apparatus may further comprise a video collecting device for collecting video information for the monitored region, wherein the receiving module may be further configured to receive the video information collected by the video collecting device. The apparatus may further comprise a local storage device for storing the video information and/or the audio information collected for a preset time period, the external device may be a client terminal of a user.

The external device may be a cloud server, the transmitting device may be further configured to transmit the video information and/or the audio information collected for a preset time period to the cloud server.

The judging module may be configured to: take sampling to the collected audio information to form time domain audio information, and divide the time domain audio information into a plurality of time domain information sections according to time order; implement Fourier transform to the plurality of time domain information sections to obtain a plurality frequency domain information sections; intercept a portion having frequencies in a feature frequency range respectively for each of the frequency domain information sections as a feature information section; judge whether an amplitude of each of the feature information sections satisfies a preset condition, record the feature information sections having amplitudes which satisfy the preset condition as valid information sections, and record the other feature information sections as invalid information sections; combine time domain waveforms corresponding to all of the valid information sections and the invalid information sections according to the time order to obtain a feature time domain waveform; and judge whether the feature time domain waveform matches waveform parameters of the feature audio information, and if so, determine that the collected audio information contains the feature audio information.

Judging whether an amplitude of each of the feature information sections satisfies a preset condition may comprise judging whether the amplitude of each of the feature information sections is greater than a preset first threshold, and may further comprise: calculating vibration volumes for at least one frequency other than the frequency corresponding to the amplitude; calculating a ratio of the amplitude to each of the vibration volumes for the at least one frequency respectively; and judging whether each of the ratios is greater than a preset second threshold.

Before intercepting a portion having frequencies in a feature frequency range respectively for each of the frequency domain information sections as a feature information section, the judging module may be further configured to: divide each of the frequency domain information sections into a plurality of frequency bands according to frequency; calculate an average vibration volume for each of the frequency bands; calculate a ratio of the average vibration volume of a frequency band corresponding to the feature frequency range to the sum of the average vibration volumes of all of the other frequency bands; and determine that the current frequency domain information section does not contain the feature information section if the ratio is falling within a preset ratio range, and terminate processing for the current frequency domain information section.

The apparatus may further comprise at least one of: a displaying device connected to the processor and configured to display a current operating state of the security monitoring apparatus; an infrared illumination device connected to the processor and configured to improve quality of video collecting at night; a speaker device connected to the processor and configured to generate an alarming sound when it is determined that the collected audio information contains the feature audio information; an apparatus rotating device connected to the processor and configured to enable the security monitoring apparatus rotate in place; and an external interface device connected to the processor and configured to connect the security monitoring apparatus to a wired network to access Internet and achieve transmission of data if the transmitting device fails.

According to embodiments of the present invention, a camera including a security monitoring apparatus as described above is also provided.

With the security monitoring method, the security monitoring apparatus and the camera including the security monitoring apparatus according to embodiments of the present invention, a function of “smart alarming through listening” can be achieved by collecting audio information for a monitored region and analyzing the feature audio information in the audio information. In this way, even if there is no person in the monitored region or there is no person monitoring the region, the alarming message can be transmitted to the client terminal of the user automatically so as to remind the user to take corresponding actions in time. In addition, when it is determined that the collected audio information contains the feature audio information, the video information and/or the audio information collected for a preset time period can be stored for the user to view the accident happened in the monitored region later.

### BRIEF DESCRIPTION OF DRAWINGS

These and/or other aspects will become apparent and more readily appreciated from the following description of the embodiments, taken in conjunction with the accompanying drawings in which:

FIG. 1 is a schematic flow chart illustrating a security monitoring method according to an embodiment of the present invention;

FIG. 2 is a schematic flow chart illustrating steps of identifying feature audio information in the security monitoring method according to an embodiment of the present invention;

FIG. 3 is a schematic diagram illustrating a structure of a security monitoring device according to an embodiment of the present invention;

FIG. 4 is a schematic diagram illustrating a structure of a security monitoring device according to another embodiment of the present invention; and

FIG. 5 is a schematic diagram illustrating a structure of a security monitoring device according to still another embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present invention.

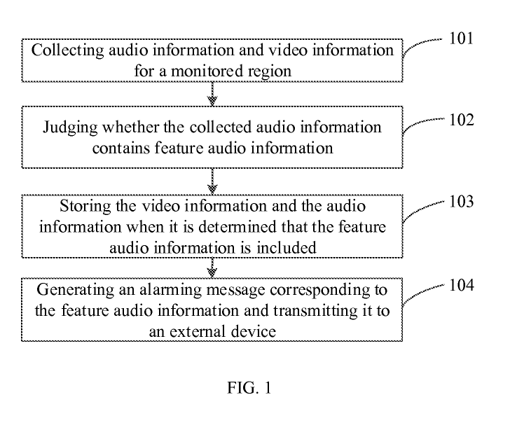

FIG. 1 is a schematic flow chart illustrating a security monitoring method according to an embodiment of the present invention. As shown in FIG. 1, a security monitoring method comprises the following steps.

At step 101, video information and audio information is collected for a monitored region. Here, the video information can be collected by a video collecting device such as a camera, and the audio information can be collected by an audio collecting device such as a microphone. The video collecting device and the audio collecting device can be integrated in one apparatus, for example, the microphone can be integrated into the camera. Although both of the video information and the audio information is collected in this embodiment, this invention is not limited thereto. Instead, those skilled in the art will readily appreciate that only the audio information may be collected.

At step 102, it is judged whether the collected audio information contains feature audio information.

In an embodiment of the invention, the feature audio information may be feature audio information in preset alarming audio. The preset alarming audio may be from smoke alarms, carbon monoxide alarms or other commercially available alarms. It is understood by those skilled in the art that although commercially available alarms have different specifications due to different vendors, alarming audio from these alarms should comply with relevant standards which define frequency features and time domain waveform features of the alarming audio. These frequency features and time domain waveform features form feature audio information through which corresponding alarming contents, such as smoke alarming or carbon monoxide alarming, can be identified.

For example, according to security monitoring standards UL217, UL2034, UL464 and UL1971 in U.S.A., alarming audio from smoke alarms should comply with the “Temporal 3” standard. Specifically, an alarming sound contains three consecutive beeps, each of the beeps lasts about 500 ms, and there is an interval of about 500 ms between every two consecutive beeps. The sound frequency is between 2900˜3500 Hz. There is an interval of about 1.5 seconds between two consecutive alarming sounds. It could be seen that the period of alarming sound under “Temporal 3” is about 4 seconds. Similarly, alarming audio from carbon monoxide alarms should comply with the “Temporal 4” standard. Specifically, an alarming sound contains four consecutive beeps, each of the beeps lasts about 100 ms, and there is an interval of about 100 ms between every two consecutive beeps. The sound frequency is between 2900˜3500 Hz. There is an interval of about 5 seconds between two consecutive alarming sounds. It could be seen that the period of alarming sound under “Temporal 4” is about 6 seconds.

In an embodiment of the present invention, the preset alarming audio may be a self-defined alarming audio after pre-learning. That is, feature audio information in sounds from a certain type of alarms or self-defined alarming sounds, e.g., HELP!, is pre-learned so as to be used in identification for collected audio information. Here, the pre-learning can be implemented with any current audio per-learning method and details thereof are omitted herein in order to avoid redundancy.

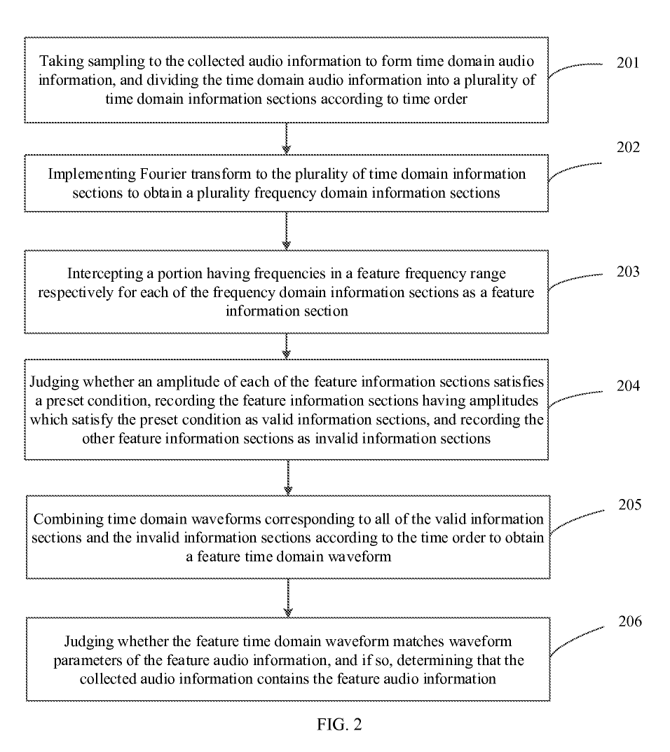

In an embodiment of the present invention, the step of judging is implemented with a combination of time domain analysis and frequency domain analysis. As the time domain analysis, the vibration volumes of sounds at different time points as well as the relationship between the envelope of the vibration and the amount of time are analyzed. As the frequency domain analysis, how many sounds having different frequencies being included in an original sound signal, the phase relationship among the sounds and impact of mutual superimposition is analyzed for a period of time. Through the frequency domain analysis, sounds having frequencies in specific frequency ranges can be identified from the audio information. Then the vibration volumes of sounds in the time domain space are calculated for the identified sounds. Here, the vibration volume reflects the intensity of the sound which has ‘decibel (dB)’ as unit. The maximum value of the vibration volumes within a frequency range is referred as an amplitude. Lastly, the sound waveforms at these specific frequencies are compared with the sound waveforms of the feature audio, and if they match, it could be concluded that the collected audio information contains the feature audio information. Detailed steps of judging will be described later with reference to FIG. 2.

At step 103, if it is determined that the feature audio information is included, the video information and the audio information collected for a preset time period is stored. Here, such information can be stored in a local storage or in a cloud server. Although in this embodiment both of the video information and the audio information is stored, this invention is not limited thereto. Instead, those skilled in the art will readily appreciate that only the audio information may be stored.

The preset time period may include a period of time before the feature audio information is identified and a period of time after that. In this case, a user is capable of obtaining enough information to identify the reason of the accident and/or truth of the alarming. Alternatively, the preset time period may include only a period of time after the feature audio information is identified to save energy consumption of video collection.

In addition, those skilled in the art will readily appreciate that the step 103 may be omitted in actual applications.

At step 104, an alarming message is generated corresponding to the feature audio information and transmitted to an external device, e.g., a client terminal of the user or a cloud server. The alarming message may be a specific text message corresponding to the identified feature audio information, e.g., fire alarming or carbon monoxide leakage alarming, etc.

In addition, the audio information and/or the video information collected for a preset time period can be transmitted to the client terminal of the user. Alternatively, the audio information and the video information collected in real time can be transmitted to the client terminal of the user so that the user is capable of viewing the scene of the monitored region in real time and taking actions in time.

In an embodiment of the present invention, the video information and the audio information collected for a preset time period is stored in a cloud server, and at the same time the generated alarming message is transmitted to the cloud server. Then, the cloud server can push the alarming message to the client terminal of the user by using a message pushing service. The message pushing service is provided by the provider of the cloud server. With preset parameters, the alarming message can be pushed to the client terminal of the user by the cloud server provided that the conditions to transmit messages are satisfied.

In another embodiment of the present invention, correspondence between the apparatus collecting the audio information and the video information for the monitored region and the client terminal of the user may be stored. Such correspondence may be stored in a local storage or a cloud server. In this case, the generated alarming message may contain an identification of the apparatus collecting the audio information and the video information for the monitored region. Based on the correspondence between the apparatus collecting the audio information and the video information for the monitored region and the client terminal of the user, the alarming message can be transmitted to the client terminal of the user corresponding to the apparatus collecting the audio information and the video information for the monitored region.

For example, in a case that the client terminal of the user is a portable mobile device such as a mobile phone and the apparatus for collecting the audio information and the video information is a monitoring camera, after buying the monitoring camera, the user may install a corresponding client software (APP) onto his/her portable mobile device and register an account with his/her mobile phone number in the client software. In this way, the account is associated with the identification of the apparatus for collecting the audio information and the video information, and the correspondence may be stored in a cloud server. When there is an accident in the monitored region and thus an alarming message is generated, the alarming message is transmitted to the cloud server. The cloud server finds the corresponding account based on the identification of the apparatus for collecting the audio information and the video information which is included in the alarming message, and pushes the alarming message to the corresponding portable mobile device of the user by using the message pushing service. Here, a plurality of portable mobile devices may be associated with a same account, and the plurality of portable mobile devices may receive a same alarming message.

FIG. 2 is a schematic flow chart illustrating steps of identifying feature audio information in the security monitoring method according to an embodiment of the present invention.

As shown in FIG. 2, at step 201, the collected audio information is taken sampling to form time domain audio information, and the time domain audio information is divided into a plurality of time domain information sections according to time order.

The originally collected audio information is expressed as analogic signals. In order to judge whether the audio information contains the feature audio information, the audio information having a status of analogic signals is taken sampling so as to obtain digital signals, which is also referred as AD conversion.

There are two basic parameters in the AD conversion: sampling rate and resolution. The sampling rate refers to the speed of taking sampling for the original signals, typically the number of sampling in one second, with KHz or MHz being the unit. The higher the sampling rate is, the more accurate expression of the original signals is. The resolution refers to the minimum value of sampling for the original signals. Generally, the resolution is one of 8 bits, 16 bits and 24 bits. By using the above-described AD conversion, the audio information having a status of analogic signals can be transferred to the time domain audio information having a status of digital signals. Then the time domain audio information is divided into a plurality of time domain information sections.

At step 202, the plurality of time domain information sections are implemented Fourier transform to obtain a plurality frequency domain information sections. Ordered data in the time domain information sections indicates relationship between the volumes of sound vibration and time, thus the time domain information sections are referred as time domain spaces. These ordered data in the time domain spaces are implemented Fourier transform, such as discrete Fourier transform (DFT) or Fast Fourier Transform (FFT), so that frequency domain spaces, i.e., frequency information sections, corresponding to the ordered data are obtained. The frequency domain spaces indicate relationship between the frequencies and sound intensities.

At step 203, a portion having frequencies in a feature frequency range, i.e., the frequency range corresponding to the preset alarming audio, is intercepted respectively for each of the frequency domain information sections as a feature information section, so that impact by noises other than the preset alarming audio is avoided. For example, alarming audio from standard “Temporal 3” smoke alarms and that from standard “Temporal 4” carbon monoxide alarms have the sound frequencies between 2900˜3500 Hz. Thus, in order to identify the smoke alarming audio and the carbon monoxide alarming audio, a portion having frequencies in a feature frequency range of 2900˜3500 Hz is intercepted among each of the frequency domain information sections as the feature information section to be used in the following frequency domain analysis. It could be understood that if there is no a portion having frequencies in a feature frequency range of 2900˜3500 Hz, it means that there is no alarming audio in the current frequency domain information sections and thus there is no need to implement the following processing.

At step 204, it is judged whether the amplitude of each feature information section satisfies a preset condition. And the feature information sections having amplitudes which satisfy the preset condition are recorded as valid information sections, and the other feature information sections are recorded as invalid information sections.

Since each feature information section has frequencies in the feature frequency range, each feature information section contains alarming audio to be identified. When the amplitude of a certain feature information section is greater than a preset first threshold, such a feature information section is regarded as corresponding to a pulse of the preset alarming audio, and thus is recorded as a valid information section. In contrast, when the amplitude of a certain feature information section is less than the first threshold, such a feature information section is regarded as corresponding to a pulse interval of the preset alarming audio, and thus is recorded as an invalid information section. After the judging for each of the feature information sections, a plurality of valid information sections and a plurality of invalid information sections which respectively correspond to specific time periods are obtained.

In order to further eliminate impact by noise in the feature frequency range so as to implement more accurate identification for the feature audio information, vibration volumes for at least one frequency other than the frequency corresponding to the amplitude are calculated. If the ratio of the amplitude to each of the vibration volumes for the at least one frequency is greater than a preset second threshold, meanwhile the amplitude is greater than the first threshold, the corresponding information sections will be recorded as valid information sections.

At step 205, time domain waveforms corresponding to all of the valid information sections and invalid information sections are combined according to time order so that a feature time domain waveform is obtained. Specifically, the plurality of valid information sections and the plurality of invalid information sections are transferred to the form of time domain space, and then are combined according to time order, so that the feature time domain waveform in the feature frequency range is obtained for the collected audio information.

At step 206, it is judged whether the feature time domain waveform matches the waveform parameters of the feature audio information. If so, it can be determined that the collected audio information contains the feature audio information.

As described above, the feature audio information may be the feature audio information in the preset alarming audio. Since the preset alarming audio usually complies with relevant standards or is pre-learned, the waveform parameters, e.g., pulse width (ms) and pulse interval width (ms), of the sound waveform are definite. Through comparing the feature time domain waveform and the waveform parameters of the preset alarming audio, it can be judged whether the collected audio information contains the feature audio information of the preset alarming audio visually.

In order to avoid “false reporting”, in an embodiment, other frequencies not falling in the feature frequency range are further analyzed for each frequency domain information section, so as to judge whether a signal in the feature frequency range is indeed noise. Specifically, before a portion having frequencies in the feature frequency range is intercepted among each of the frequency domain information sections as the feature information sections, each frequency domain information section is divided into a plurality of frequency bands according to the frequency. The plurality of frequency bands include the frequency band corresponding to the feature frequency range. For example, a frequency domain information section having a frequency range of 35˜5500 Hz is divided into 22 frequency bands. The 22 frequency bands include the frequency band corresponding to the frequency range of 2900˜3500 Hz which is the feature frequency range based on the “Temporal 3” standard and the “Temporal 4” standard. Then an average vibration volume is calculated for each of the frequency bands, and then a ratio of the average vibration volume of the frequency band corresponding to the feature frequency range to the sum of the average vibration volumes of all of the other frequency bands is calculated. If the ratio falls within a preset ratio range, it can be concluded that the sound corresponding to the portion having a frequency in the feature frequency range in the current frequency domain information section is indeed noise. That is, the current frequency domain information section does not contain the feature information section. In this case, step S203 is not needed to be implemented.

Those skilled in the art will appreciate that the above-mentioned “the first threshold”, “the second threshold” and “the ratio range” can be determined and adjusted based on the sound signals to be collected and the type of the preset alarming audio, thus the specific numbers of “the first threshold”, “the second threshold” and “the ratio range” are not limited thereto.

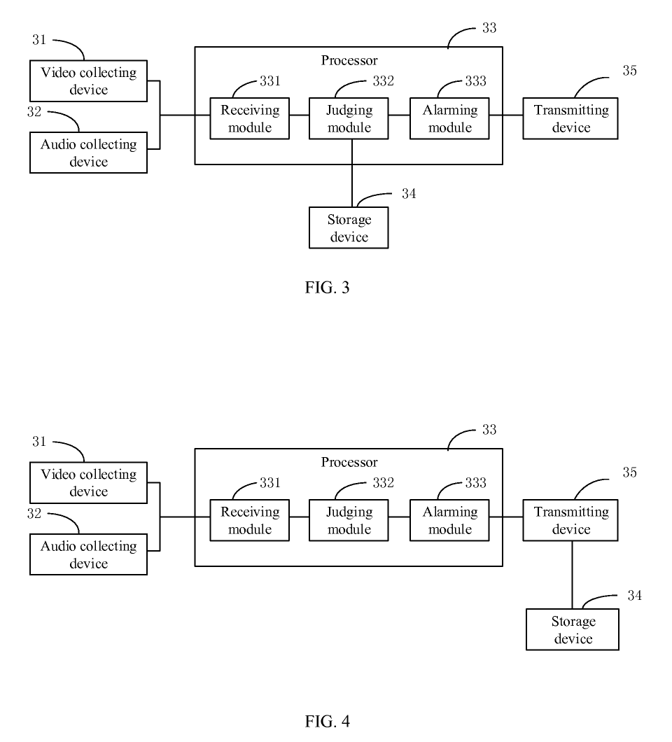

FIG. 3 is a schematic diagram illustrating a structure of a security monitoring device according to an embodiment of the present invention. As shown in FIG. 3, a security monitoring apparatus according to this embodiment comprises a video collecting device 31, an audio collecting device 32, a storage device 34, a transmitting device 35 and a processor 33 connected to the video collecting device 31, the audio collecting device 32, the storage device 34 and the transmitting device 35 respectively.

The processor 33 includes a receiving module 331, a judging module 332 and an alarming module 333 which are connected sequentially. The receiving module 331 receives video information and audio information collected by the video collecting device 31 and the audio collecting device 32 for the monitored region respectively. The judging module 332 judges whether the audio information contains feature audio information. And if it is determined that the audio information contains feature audio information, the judging module 332 transmits the video information and the audio information collected for a preset time period to the storage device 34, and meanwhile informs the alarming module 333 to generate an alarming message corresponding to the feature audio information. The alarming module 333 generates and transmits the alarming message to the transmitting device 35 which then transmits the alarming message to the client terminal of the user.

The detailed processing implemented by the judging module 332 comprises the steps described with reference to FIG. 2 above, thus repeated description will be omitted hereinafter to avoid redundancy.

In addition, similar to the description above with reference to FIG. 1, the video collecting device 31 may be omitted in other embodiments. For example, only audio information is collected and stored.

In this embodiment as shown in FIG. 3, the storage device 34 is a local storage. Alternatively, as shown in FIG. 4 which is a schematic diagram illustrating a structure of a security monitoring device according to another embodiment of the present invention, the storage device 34 may be a cloud server supporting the message pushing service. In this case, the storage device 34 is not included in the security monitoring apparatus, instead it is a standalone device. The transmitting device 35 transmits the alarming message to the cloud server which then pushes the alarming message to the client terminal of the user by using the message pushing service. In addition, the transmitting device 35 may transmit the video information and the audio information collected for a preset time period to the storage device 34, i.e. the cloud server for storing. In other embodiments, the storage device 34 in FIG. 3 may be omitted.

In an embodiment of the present invention, the video collecting device 31 is a CCD optical image sensor or a CMOS optical image sensor. In order to monitor a wide region, the video collecting device 31 may include a head which can rotate 360°, so that the video collecting device 31 can rotate around its own axis. Alternatively, the video collecting device 31 may be fixed to a certain position without a head so that a fixed region is monitored.

Although the above-described embodiments describe several modules of the security monitoring apparatus, those skilled in the art will appreciate that some of these modules can be integrated or further distributed.

In addition, the embodiments of the present invention can be implemented through combination of hardware and software. The hardware can be implemented using dedicated logic. The software can be stored in a memory and implemented by a suitable instruction execution system, such as a microprocessor or a dedicated hardware. Those skilled in the art will appreciate that the above-described apparatus and methods may be implemented using computer-executable instructions and/or processor control codes which may be provided in a carrier medium such as a disk, CD or DVD-ROM, a programmable memory such as a read-only memory (firmware), or a data carrier such as an optical or electrical signal carrier. The devices and modules according to this invention may be implemented by VLSI or gate arrays, semiconductor such as logic chips and transistors, or a hardware circuit of a programmable hardware device such as a field programmable gate array, a programmable logic device, etc. Alternatively, the devices and modules according to this invention may be implemented by software which can be executed by various types of processors, or by combination of hard circuits and software, such as firmware. For example, when the security monitoring equipment according to this invention is implemented by hardware, the processor 33 may be a large scale integrated circuit board, the receiving module 331 may be any commercially available audio processing device which can take sampling for sounds, the judging module 332 may be a signal processing device which can implement frequency determination and waveform processing for the processed sound signals, such as a filter, the alarming module 333 may be a relay device which can generate an electronic signal representative of an alarming message, and the transmitting device 35 may be commercially available network card supporting wired network connection and/or wireless network connection.

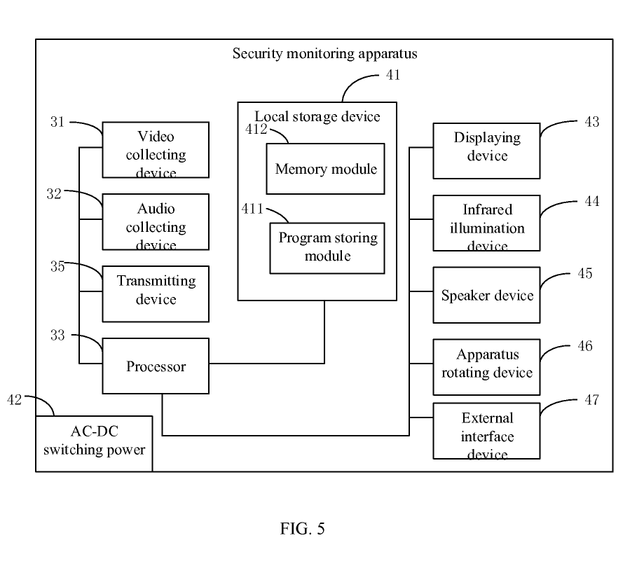

FIG. 5 is a schematic diagram illustrating a structure of a security monitoring device according to still another embodiment of the present invention. A video collecting 31, an audio collecting device 32, a processor 33 and a transmitting device 35 are the same or substantially the same as those included in FIG. 3 or FIG. 4, thus repeated description thereof will be omitted herein and only difference will be described thereinafter.

Unlike the embodiment shown in FIG. 3, the video information and the audio information collected for a preset time period is not stored in a local memory device 41, instead they are transmitted to a cloud server (not shown in FIG. 5) for storing via the transmitting device 35. Furthermore, the generated alarming message is transmitted to the cloud server by the transmitting device 35, and the cloud server pushes the alarming message to the client terminal of the user by using the message pushing service.

The local storage device 41 includes a memory module 411 for storing codes to be executed by the processor 33 and a program storing module 412 for providing hardware environment required to run programs. In addition, an AC-DC switching power 42 (a standalone device) is used to provide power to the entire security monitoring apparatus.

Furthermore, the security monitoring apparatus shown in FIG. 5 further includes one or more of the following devices which are connected to the processor 33 respectively: a displaying device 43 for displaying the current operating state of the security monitoring apparatus; an infrared illumination device 44 for improving the quality of video collecting at night; a speaker device 45 for generating an alarming sound when it is determined that the collected audio information contains the feature audio information; an apparatus rotating device 46 for enabling the security monitoring apparatus rotate in place so that a wide region can be monitored; and an external interface device 47, e.g., a wired interface device, for connecting to a wired network to access Internet and achieve transmission of data if the transmitting device 35 supporting wireless transmission fails.

In addition, a camera integrating the security monitoring apparatus according to any of embodiments shown in FIGS. 3-5 is provided in this invention. Since integration of the security monitoring apparatus, the camera has a function of “alarming through listening”.

With the security monitoring method, the security monitoring apparatus and the camera including the security monitoring apparatus according to embodiments of the present invention, a function of “smart alarming through listening” can be achieved by collecting audio information for a monitored region and analyzing the feature audio information in the audio information. In this way, even if there is no person in the monitored region or there is no person monitoring the region, the alarming message can be transmitted to the client terminal of the user automatically so as to remind the user to take corresponding actions in time. In addition, when it is determined that the collected audio information contains the feature audio information, the video information and/or the audio information collected for a preset time period can be stored for the user to view the accident happened in the monitored region later.

It should be understood that the embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. A security monitoring method, comprising:
collecting audio information for a monitored region;
judging whether the collected audio information contains feature audio information;
generating an alarming message corresponding to the feature audio information if it is determined that the collected audio information contains the feature audio information; and
transmitting the alarming message to an external device.

2. The method of claim 1, further comprising collecting video information for the monitored region.

3. The method of claim 2, further comprising storing the video information and/or the audio information collected for a preset time period.

4. The method of claim 3, wherein the video information and/or the audio information collected for the preset time period is stored in a local storage, the external device is a client terminal of a user.

5. The method of claim 3, wherein the video information and/or the audio information collected for the preset time period is stored in a cloud server, the external device is the cloud server,
wherein the method further comprises transmitting the alarming message to a client terminal of a user by the cloud server using a message pushing service.

6. The method of claim 1, wherein judging whether the collected audio information contains feature audio information comprises:
taking sampling to the collected audio information to form time domain audio information, and dividing the time domain audio information into a plurality of time domain information sections according to time order;
implementing Fourier transform to the plurality of time domain information sections to obtain a plurality frequency domain information sections;
intercepting a portion having frequencies in a feature frequency range respectively for each of the frequency domain information sections as a feature information section;
judging whether an amplitude of each of the feature information sections satisfies a preset condition, recording the feature information sections having amplitudes which satisfy the preset condition as valid information sections, and recording the other feature information sections as invalid information sections;
combining time domain waveforms corresponding to all of the valid information sections and the invalid information sections according to the time order to obtain a feature time domain waveform; and
judging whether the feature time domain waveform matches waveform parameters of the feature audio information, and if so, determining that the collected audio information contains the feature audio information.

7. The method of claim 6, wherein judging whether an amplitude of each of the feature information sections satisfies a preset condition comprises judging whether the amplitude of each of the feature information sections is greater than a preset first threshold.

8. The method of claim 7, wherein judging whether an amplitude of each of the feature information sections satisfies a preset condition further comprises:
calculating vibration volumes for at least one frequency other than the frequency corresponding to the amplitude;
calculating a ratio of the amplitude to each of the vibration volumes for the at least one frequency respectively; and
judging whether each of the ratios is greater than a preset second threshold.

9. The method of claim 6, before intercepting a portion having frequencies in a feature frequency range respectively for each of the frequency domain information sections as a feature information section, further comprising:
dividing each of the frequency domain information sections into a plurality of frequency bands according to frequency;
calculating an average vibration volume for each of the frequency bands;
calculating a ratio of the average vibration volume of a frequency band corresponding to the feature frequency range to the sum of the average vibration volumes of all of the other frequency bands; and
determining that the current frequency domain information section does not contain the feature information section if the ratio is falling within a preset ratio range, and terminating processing for the current frequency domain information section.

10. The method of claim 1, wherein the feature audio information comprises one or more of alarming audio from a smoke alarm, alarming audio form a carbon monoxide alarm and self-defined alarming audio after pre-learning.

11. A security monitoring apparatus, comprising:
an audio collecting device for collecting audio information for a monitored region;
a processor, comprising:
a receiving module for receiving the audio information collected by the audio collecting device;
a judging module for judging whether the collected audio information contains feature audio information; and
an alarming module for generating an alarming message corresponding to the feature audio information if it is determined that the collected audio information contains the feature audio information; and
a transmitting device for transmitting the alarming message to an external device.

12. The apparatus of claim 11, further comprising a video collecting device for collecting video information for the monitored region, wherein the receiving module is further configured to receive the video information collected by the video collecting device.

13. The apparatus of claim 12, further comprising a local storage device for storing the video information and/or the audio information collected for a preset time period, the external device is a client terminal of a user.

14. The apparatus of claim 12, wherein the external device is a cloud server, the transmitting device is further configured to transmit the video information and/or the audio information collected for a preset time period to the cloud server.

15. The apparatus of claim 11, wherein the judging module is configured to:
take sampling to the collected audio information to form time domain audio information, and divide the time domain audio information into a plurality of time domain information sections according to time order;
implement Fourier transform to the plurality of time domain information sections to obtain a plurality frequency domain information sections;
intercept a portion having frequencies in a feature frequency range respectively for each of the frequency domain information sections as a feature information section;
judge whether an amplitude of each of the feature information sections satisfies a preset condition, record the feature information sections having amplitudes which satisfy the preset condition as valid information sections, and record the other feature information sections as invalid information sections;
combine time domain waveforms corresponding to all of the valid information sections and the invalid information sections according to the time order to obtain a feature time domain waveform; and
judge whether the feature time domain waveform matches waveform parameters of the feature audio information, and if so, determine that the collected audio information contains the feature audio information.

16. The apparatus of claim 15, wherein judging whether an amplitude of each of the feature information sections satisfies a preset condition comprises judging whether the amplitude of each of the feature information sections is greater than a preset first threshold.

17. The apparatus of claim 16, wherein judging whether an amplitude of each of the feature information sections satisfies a preset condition further comprises:
calculating vibration volumes for at least one frequency other than the frequency corresponding to the amplitude;
calculating a ratio of the amplitude to each of the vibration volumes for the at least one frequency respectively; and
judging whether each of the ratios is greater than a preset second threshold.

18. The apparatus of claim 15, wherein before intercepting a portion having frequencies in a feature frequency range respectively for each of the frequency domain information sections as a feature information section, the judging module is further configured to:
divide each of the frequency domain information sections into a plurality of frequency bands according to frequency;
calculate an average vibration volume for each of the frequency bands;
calculate a ratio of the average vibration volume of a frequency band corresponding to the feature frequency range to the sum of the average vibration volumes of all of the other frequency bands; and
determine that the current frequency domain information section does not contain the feature information section if the ratio is falling within a preset ratio range, and terminate processing for the current frequency domain information section.

19. The apparatus of claim 11, further comprising at least one of:
a displaying device connected to the processor and configured to display a current operating state of the security monitoring apparatus;
an infrared illumination device connected to the processor and configured to improve quality of video collecting at night;
a speaker device connected to the processor and configured to generate an alarming sound when it is determined that the collected audio information contains the feature audio information;
an apparatus rotating device connected to the processor and configured to enable the security monitoring apparatus rotate in place; and
an external interface device connected to the processor and configured to connect the security monitoring apparatus to a wired network to access Internet and achieve transmission of data if the transmitting device fails.

20. A camera including a security monitoring apparatus of claim 11.
